(19) United States
(12) Patent Application Publication
(10) Pub. No.: US 2010/0253665 A1
(43) Pub. Date: Oct. 7, 2010

(54) CURRENT BALANCING APPARATUS, POWER SUPPLY APPARATUS, LIGHTING APPARATUS, AND CURRENT BALANCING METHOD THEREOF

(75) Inventors: Sung-jin CHOI, Gunpo-si (KR); Tae-hoon KIM, Suwon-si (KR); Pankaj AGARWAL, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/689,621

(22) Filed: Jan. 19, 2010

(30) Foreign Application Priority Data
Apr. 1, 2009 (KR) 2009-0028187

(51) Int. Cl. G06F 3/038

(52) U.S. Cl. 345/211

(57) ABSTRACT

A current balancing apparatus, a power supply apparatus, a lighting apparatus, and a current balancing method for preventing luminance imbalance are provided. The current balancing apparatus includes a balancer for balancing an AC current and a rectifier for generating a DC current by rectifying the balanced current. Hence, the luminance imbalance caused by dispersion of a light source can be addressed.

### CROSS-REFERENCE TO RELATED APPLICATIONS

This application claims priority from Korean Patent Application No. 2009-28187, filed on Apr. 1, 2009, in the Korean Intellectual Property Office, the disclosure of which is incorporated herein by reference in its entirety.

### BACKGROUND OF THE INVENTION

1. Field of the Invention

Apparatuses and methods consistent with the present invention relate to a current balancing apparatus, a power supply apparatus, a lighting apparatus, and a current balancing method thereof, and more particularly, to a current balancing apparatus, a power supply apparatus, a lighting apparatus, and a current balancing method for preventing a luminance imbalance caused by dispersion of a light source.

2. Description of the Related Art

In accordance with the growth of information processing technology, display techniques for displaying information is also advancing rapidly. The advance of the display techniques radically decreases the demand for conventional Cathode Ray Tubes (CRT) and increases the demand for flat panel displays such as Liquid Crystal Displays (LCD).

Typically, the LCD represents video to a user by emitting the light produced at the light source in a rear side to a front panel using changes in the light transmission of liquid crystals in accordance with a voltage applied to the panel. The LCD, which cannot illuminate by itself, requires the separate light resource which is a backlight.

A Light Emitting Diode (LED) is environmentally friendly, allows a rapid response speed within several nanoseconds, features a long life span, and thus has been recently employed as the light source for the backlight of LCD panels.

Since the light sources for the backlight are distributed over the LCD panel, a driving circuit technique is required to avoid luminance imbalance according to dispersion of the light sources. Some of suggestions for preventing the luminance imbalance employ a plurality of linear regulators or a plurality of boost converters, consuming too many components. Hence, the system configuration is inefficient and the space for the circuit implementation increases. As a result, such a construction is not suitable for the thinness of the LCD backlight.

Therefore, what is needed is a technique for addressing the luminance imbalance according to the dispersion of the light source and for achieving the thinness of the LCD panel at the same time.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a current balancing apparatus, a power supply apparatus, and a lighting apparatus, and a current balancing method for accomplishing current balancing, high efficiency, and thinness.

According to an aspect of the present invention, a current balancing apparatus includes a balancer which balances an input Alternating Current (AC) current by impedance balancing; and a rectifier which generates a Direct Current (DC) current by rectifying the balanced current.

The balancer may include at least one balancing capacitor. The impedance balancing may set a frequency of the AC current input to the balancing capacitor to a value lower than a preset value.

The preset value may be within a range where an impedance value in view of the balancing capacitor toward the rectifier is negligible compared to an impedance value of the balancing capacitor.

The balancer may include at least one balancing capacitor, and the capacitor is connected with the rectifier in series.

The rectifier may apply the DC current to a plurality of loads, and the balancer may balance the AC current such that the same DC current is input to the plurality of the loads or such that the DC current input to one of the plurality of the loads is equal to a DC current input to another of the plurality of loads connected to another balancer.

The rectifier may apply the DC current output from a primary end of the rectifier to a first load when the AC current is in a positive cycle, and apply the DC current output from a secondary end of the rectifier to a second load when the AC current is in a negative cycle.

The rectifier may include a first capacitor connected to the first load in parallel; and a second capacitor connected to the second load in parallel. The current output from the first capacitor may be input to the first load when the AC current is in the negative cycle, and the current output from the second capacitor may be input to the second load when the AC current is in the positive cycle.

The first load and the second load may be a first Light Emitting Diode (LED) array and a second LED array, respectively.

According another aspect of the present invention, a power supply apparatus includes an inverter which converts a DC current to an AC current; a transformer which converts the AC current which is a primary end current, to a plurality of secondary end currents and transfers the converted currents; and a plurality of balancers which receive the secondary end currents, balance the secondary currents end by impedance balancing, and generate a plurality of DC currents by rectifying the balanced currents.

The plurality of balancers may transfer the plurality of DC currents to a plurality of load sets, respectively, and the load sets may include LED array pairs.

The plurality of balancers may be linked to one secondary coil of the transformer in parallel, or to a plurality of secondary coils of the transformer, respectively.

When the plurality of balancers are connected to the one secondary coil of the transformer, each of the plurality of balancers may include two balancing capacitors, one balancing capacitor of each of the plurality of balancers linked to one end of the secondary coil, and the other balancing capacitor of each of the plurality of balancers linked to the other end of the secondary coil.

When the plurality of balancers are connected to the plurality of secondary coils of the transformer, the plurality of balancers each may include a balancing capacitor linked to one end of the secondary coil.

The plurality of DC currents may be applied to the plurality of load sets, the currents output from the load sets are combined and input to the inverter. The inverter may receive the combined current, control a duty or a frequency of the DC current based on the combined current, chop and convert the DC current to the AC current of a certain level based on the duty control or the frequency control.

According yet another aspect of the present invention, a lighting apparatus includes a power supply apparatus which balances an AC current by impedance balancing, and generates a plurality of DC currents by rectifying the balanced current; and a plurality of LED array pairs which receive the plurality of the DC currents generated by the power supply apparatus.

According still another aspect of the present invention, a current balancing method includes balancing an input AC current by impedance balancing; and generating a DC current by rectifying the balanced current.

The impedance balancing may set a frequency of the AC current input to a balancing capacitor to a value lower than a preset value.

The preset value may be within a range where an impedance value seen by the balancing capacitor looking toward the rectifier is negligible compared to an impedance value of the balancing capacitor.

### BRIEF DESCRIPTION OF THE DRAWINGS

The above and/or other aspects of the present invention will become more apparent by describing certain exemplary embodiments of the present invention with reference to the accompanying drawings, in which:

FIG. 1 illustrates a lighting apparatus according to an exemplary embodiment of the present invention;

FIG. 2 is a block diagram of a Switching Mode Power Supply (SMPS) section according to an exemplary embodiment of the present invention;

FIG. 3 is a detailed circuit diagram of the SMPS section according to an exemplary embodiment of the present invention;

FIG. 4 illustrates a duty ratio control or a frequency control by a combined current output from three LED array pairs according to an exemplary embodiment of the present invention;

FIG. 5 illustrates impedance balancing and AC current balancing according to an exemplary embodiment of the present invention;

FIG. 6 illustrates impedance Zₜ, which is the total impedance of the secondary excluding the secondary coil according to an exemplary embodiment of the present invention;

FIG. 7 is a circuit diagram of the SMPS section according to another exemplary embodiment of the present invention;

FIGS. 8A and 8B illustrate circuit operations when the AC current is in a positive cycle and when the AC current is in a negative cycle, respectively, according to an exemplary embodiment of the present invention;

FIG. 9 illustrates an equivalent circuit of the secondary circuit according to an exemplary embodiment of the present invention; and

FIG. 10 illustrates an LCD display device to which the lighting apparatus can be applied according to an exemplary embodiment of the present invention.

### DETAILED DESCRIPTION OF THE EXEMPLARY EMBODIMENTS

Exemplary embodiments of the present invention are described in greater detail below with reference to the accompanying drawings.

In the following description, like drawing reference numerals are used for the like elements, even in different drawings. The matters defined in the description, such as detailed construction and elements, are provided to assist in a comprehensive understanding of the invention. However, the present invention can be practiced without those specifically defined matters. Also, well-known functions or constructions are not described in detail since they would obscure the invention with unnecessary detail.

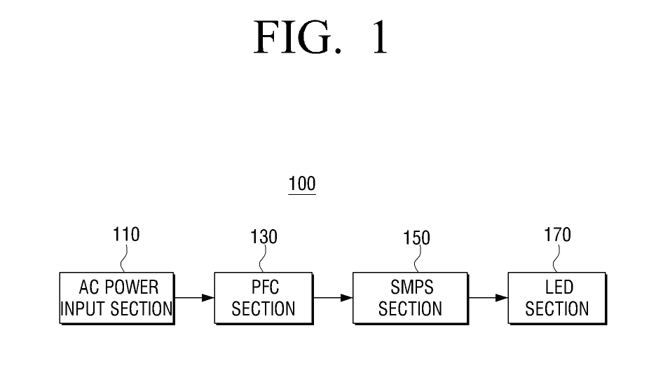

FIG. 1 illustrates a lighting apparatus according to an exemplary embodiment of the present invention. The lighting apparatus 100 provides a user with a screen having uniform luminance. The lighting apparatus 100 of FIG. 1 includes an AC power input section 110, a Power Factor Correction (PFC) section 130, a Switching Mode Power Supply (SMPS) section 150, and a Light Emitting Diode (LED) section 170.

The AC power input section 110 supplies the AC power input from external to the PFC section 130.

The PFC section 130 provides rectification and power factor correction. More specifically, by correcting the power factor of the AC power input from the AC power input section 110, the PFC section 130 supplies stabilized current to components of the lighting apparatus 100 and prevents increases in temperature or power consumption when wasted current is converted to heat. Also, the PFC section 130 converts the input AC power to DC power and provides the DC power to the SMPS section 150.

The SMPS section 150 generates DC power in an intended form (magnitude) using the DC power fed from the PFC section 130. The SMPS section 150 converts the input DC power to AC power through the switching of an inverter, converts the AC power to an intended voltage (current), rectifies the voltage, and thus produces the DC power.

The SMPS section 150 generates the DC power balanced and rectified such that the same current is input to a plurality of LED arrays of the LED section 170 as the rectified DC power. The detailed structure and operations of the SMPS section 150 is described with reference to the drawings.

The SMPS section 150 forwards the balanced and rectified DC current to the LED section 170.

The LED section 170, which is driven to radiate according to the DC current fed from the SMPS section 150, includes a plurality of LED array pairs. The LED array represents a plurality of LEDs arranged in succession, and the LED array pair represents a pair of two LED arrays. Given three LED array pairs, the total number of the LED arrays is six. The LED arrays include a red LED array, a green LED array, and a blue LED array. The lights emitting from the red LED array, the green LED array, and the blue LED array are mixed and arranged to produce white light.

Accordingly, the lighting apparatus 100 can provide light of uniform luminance.

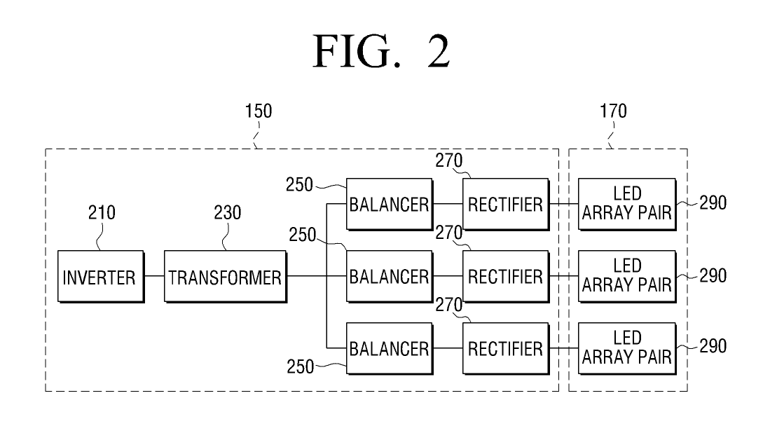

FIG. 2 is a block diagram of the SMPS section 150 according to an exemplary embodiment of the present invention. To ease the understanding of FIG. 2, the LED array pairs 290 of the LED section 170 are depicted together with the SMPS section 150. The SMPS section 150 of FIG. 2 includes an inverter 210, a transformer 230, three balancers 250, and three rectifiers 270.

The inverter 210 converts DC current to AC current through high frequency chopping. The inverter 210 outputs the converted AC current to the transformer 230.

The transformer 230 converts the primary AC current to secondary AC current. In more detail, the transformer 230 induces the primary AC current to the secondary AC current according to a winding ratio of a primary coil and a secondary coil. The transformer 230 applies the secondary AC current to the three balancers 250.

Each balancer 250 balances the AC current such that the same AC current input to the balancer 250 is output to the LED array pair 290. The balanced AC currents are applied to the three rectifiers 270.

Each rectifier 270 receives and rectifies a balanced AC current, produces a DC current of the same magnitude. The three rectifiers 270 output the DC currents to the three LED array pairs 290.

As such, the balanced and rectified DC current is fed to the LED arrays and thus luminance imbalance caused by dispersion can be addressed.

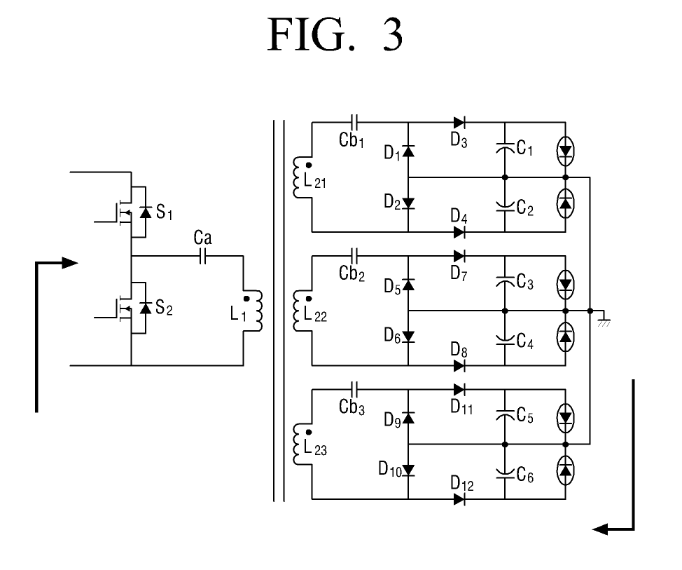

The operations of the SMPS section 150 are described in detail with reference to FIG. 3. FIG. 3 is a detailed circuit diagram of the SMPS section 150 according to an exemplary embodiment of the present invention. To ease the understanding of FIG. 3, the LED array pairs 290 of the LED section 170 are depicted together with the SMPS section 150.

The inverter 210 includes two switches S1 and S2 and a capacitor Ca, and converts the input DC current to AC current according to the high frequency chopping based on the opening and closing of the two switches S1 and S2.

More specifically, when the upper switch S1 is closed and the lower switch S2 is open, the DC current input to the both ends of the inverter 210 goes to high level. When the lower switch S2 is closed and the upper switch Si is open, the DC current input to the both ends of the inverter 210 goes to low level. By repeating these operations rapidly, the inverter 210 converts the DC current to AC current.

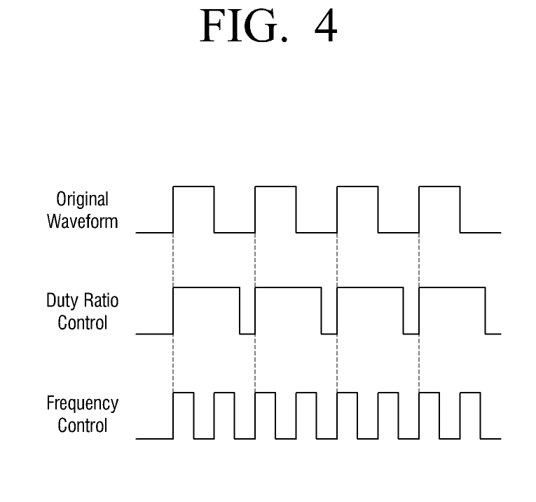

Such switching operations are controlled by the combined current output from the three LED array pairs 290, which is now explained by referring to FIG. 4.

FIG. 4 illustrates a duty ratio control or a frequency control by the combined current output from the three LED array pairs 290.

The duty ratio indicates a ratio of on-time to off-time in the pulse. The duty ratio control controls changes in the on-off times of the original waveform. When the duty ratio is controlled, the time of the on state of the upper switch S1 and the off state of the lower switch S2, and the time of the off state of the upper switch S1 and the on state of the lower switch S2, differ from each other. Correspondingly, the waveform of the current applied to the transformer 230 is changed.

When the frequency is controlled, the on state of the upper switch Si and the off state of the lower switch S2, or the off state of the upper switch Si and the on state of the lower switch S2, are repeated faster or slower. Correspondingly, the waveform of the current applied to the transformer 230 is changed.

Referring back to FIG. 3, the AC current generated by controlling the switching operations is applied to the transformer 230 via the capacitor Ca and becomes the primary current of the transformer 230.

The voltage chopped by the high frequency chopping resonates a primary resonance element which includes the primary capacitor Ca and the primary coil L1. As the combined current fed back from the secondary regulates the resonance of the primary circuit, the current induced in the secondary becomes the resonant AC current approximating a sine wave.

The transformer 230 converts the primary AC current, which is the resonant AC current, to the secondary AC current. As shown in FIG. 3, since three secondary coils L21, L22 and L23 correspond to the single primary coil L1, the three independent secondary currents are induced in the secondary coils. More specifically, the transformer 230 induces the primary AC current to the secondary AC current according to the winding ratio of the primary coil Ll and the secondary coils L21, L22 and L23.

The number of windings in each of the three secondary coils L21, L22 and L23 may be the same. When the winding ratios of the three secondary coils L21, L22 and L23 are identical, balanced AC currents can be produced.

The three secondary AC currents produced by the transformer 230 are fed to the three balancers 250, respectively. The three balancers 250 include balancing capacitors Cb1, Cb2 and Cb3. The balancing capacitors Cb1, Cb2 and Cb3 are connected to a first end of the secondary coils L21, L22 and L23 of the transformer 230.

The three balancers 250 can carry out AC current balancing through impedance balancing such that the same AC currents which are fed to the balancers 250 are output to the LED array pairs 290.

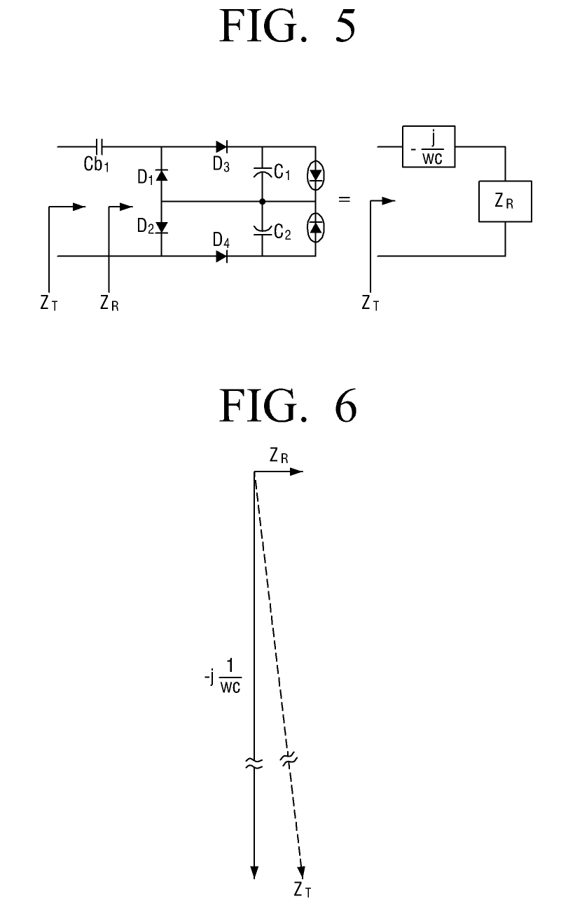

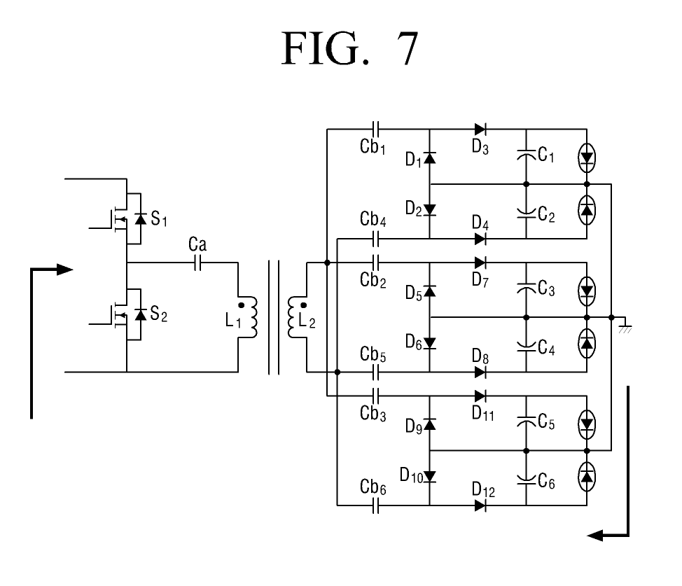

Impedance balancing and AC current balancing are explained with reference to FIGS. 5 and 6.

FIG. 5 illustrates impedance balancing and AC current balancing. To facilitate the understanding, only one balancer 250, one rectifier 270, and one LED array pair 290 are provided. Assuming that the equivalent impendence seen by the balancing capacitor Cb1 looking toward the rectifier 270 or the LED array pair 290 is Z, , the total impedance of the secondary excluding the secondary coil is given as the following equation:

$${Z}_{T} = {Z}_{R} - \frac{j}{wc} \qquad ( 1 )$$

where c is the capacitance of the balancing capacitor Cb1 and w is the frequency of the input AC current.

FIG. 6 illustrates Z_{T} which is the total impedance of the secondary excluding the secondary coil. The total impedance Z_{T} of the secondary excluding the secondary coil is Z_{R}−j/wc. When the magnitude of j/wc considerably increases because of a small magnitude of w or c, the impedance Z_{R} is negligible and can be ignored. As a result, the total impedance Z_{T} becomes −j/wc.

When the capacitance of every balancing capacitor in the three balancers 250 becomes the same while greatly decreasing the magnitude of w or c, the same currents are supplied to the LED arrays.

By means of the impedance balancing, the three balancers 250 carry out the AC current balancing to make the same AC currents which are input to the balancers 250 output to the LED array pairs 290.

Referring back to FIG. 3, the AC currents balanced at the three balancers 250 are applied to the three rectifiers 270 respectively.

The rectifiers 270 receive and rectify the balanced AC current, generate DC current of the same magnitude, and provide the generated DC current to the three LED array pairs 290.

The currents output from the three LED array pairs 290 are combined and applied to control the upper switch S1 and the lower switch S2, as stated earlier. By use of the combined current, the duty rate control or the frequency control is conducted.

Thus, by providing the balanced and rectified DC current to the LED arrays, the luminance imbalance caused by dispersion can be addressed.

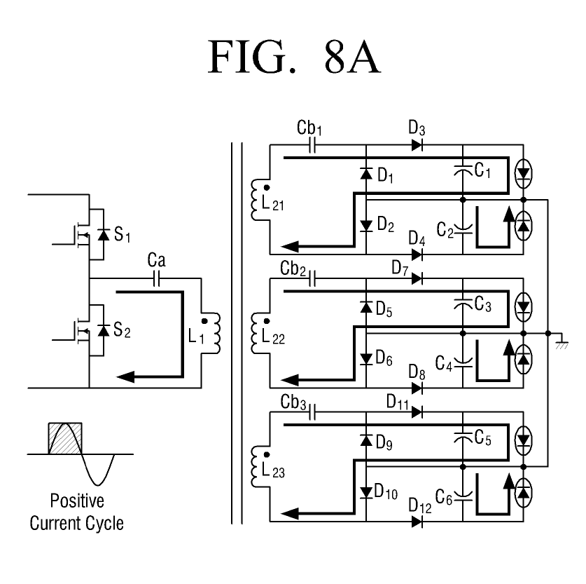

FIG. 7 is a circuit diagram of the SMPS section 150 according to another exemplary embodiment of the present invention. To ease the understanding, the LED array pairs 290 of the LED section 170 are depicted together with the SMPS section 150.

Some of the descriptions of FIG. 7 are similar to those of FIG. 3 and accordingly can be understood from the explanations of FIG. 3, which will be described in brief. Hereafter, differences of FIG. 7 from FIG. 3 are mainly illustrated.

The inverter 210 converts input DC current to AC current by high frequency chopping based on the opening and closing of switches S1 and S2. The switching operations are controlled by the combined current of the currents output from the three LED array pairs 290.

The AC current produced by controlling the switching operations is forwarded to the transformer 230 via the capacitor Ca and becomes the primary current of the transformer 230.

The transformer 230 converts the primary AC current to secondary AC current. Since the transformer 230 includes secondary coil L2 corresponding to the primary coil L1 as shown in FIG. 7, only one secondary current is induced to the secondary coil.

The secondary AC current induced at the transformer 230 is applied to the three balancers 250 linked in parallel. More specifically, the three balancers 250 each include two balancing capacitors Cb1 and Cb4, Cb2 and Cb5, and Cb3 and Cb6. The upper balancing capacitors Cb1, Cb2 and Cb3 are linked to a first end of the secondary coil L2 of the transformer 230, and the lower balancing capacitors Cb4, Cb5 and Cb6 are linked to a second end of the secondary coil L2 of the transformer 230.

As configured above, the three balancers 250 can perform the AC current balancing through the impedance balancing to output the same AC currents which are input to the balancers 250 to the LED array pairs 290.

Unlike FIG. 3, the balancers 250 each include two balancing capacitors Cb1 and Cb4, Cb2 and Cb5, and Cb3 and Cb6. Therefore, provided that the equivalent impendence seen by the balancer 250 looking toward the rectifier 270 or the LED array pair 290 is Z_{R}, the total impedance of the secondary excluding the secondary coil is given as the following equation:

$${Z}_{T} = {Z}_{R} - \frac{j 2}{wc} \qquad ( 2 )$$

where c is the capacitance of one balancing capacitor and w is the frequency of the input AC current.

The total impedance Z_{T} of the secondary excluding the secondary coil is Z_{R}−j2/we. When the magnitude of j/we considerably increases because of a small magnitude of w or c, Z_{R} is negligible and can be ignored. As a result, the total impedance Z_{T} becomes −j2/we.

When the capacitance of every balancing capacitor in the three balancers 250 becomes the same while greatly decreasing the magnitude of w or c, the same currents are supplied to the LED arrays.

By means of the impedance balancing as described above, the three balancers 250 carry out the AC current balancing to output the same AC currents which are input to the balancers 250 to the LED array pairs 290, and supplies the balanced and rectified DC current to the LED arrays to thus address the luminance imbalance caused by dispersion of the light sources.

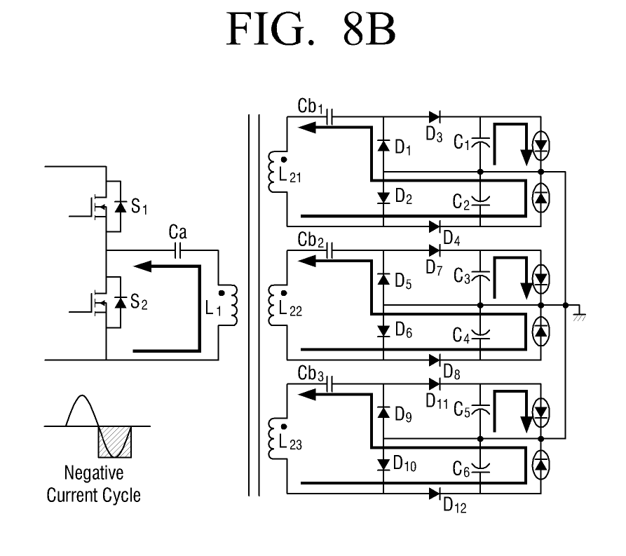

As described thus far, the input DC current is converted to AC current by high frequency chopping based on the opening and closing of the switches S1 and S2 of the inverter 210, and the converted AC current is applied to the transformer 230. Hereinafter, explanations provide the detailed circuit operations when the converted AC current is in the positive cycle and when the converted AC current is in the negative cycle by referring to FIGS. 8A and 8B. In particular, of the exemplary embodiments of FIGS. 3 and 7, the former is mainly described. However, this is merely for convenience of explanation and the following explanation can be applied to the exemplary embodiment of FIG. 7.

FIG. 8A illustrates circuit operations when the AC current is in the positive cycle. In the positive cycle, as the upper switch S1 of the inverter 210 is closed and the lower switch S2 is opened, the DC current input to the both ends of the inverter 210 is at the high level. Current flows in a clockwise direction from the upper switch Si toward the coil L1 by way of the capacitor Ca.

The current (the primary current) is induced by the transformer 230 to the three secondary coils. In view of the uppermost secondary circuit, the induced secondary current flows from the coil L21 to the upper LED array of the LED array pairs 290 via the balancing capacitor Cb1 and the diode D3. Thus, the upper LED array radiates in proportion to the applied current.

The current passing through the upper LED array flows to the coil L21 via the diode D2. Consequently, the current loop of the coil L21—the balancing capacitor Cb1—the diode D3—the upper LED array—the diode D2—the coil L21 is formed.

When the AC current stays in the positive cycle, electric charges corresponding to the voltage drop of the upper LED array are accumulated at the capacitor C1. Likewise, the electric charges accumulated at the capacitor C2 during the negative cycle before the positive cycle move to the lower LED array of the LED array pairs 290. Thus, the lower LED array radiates in proportion to the applied current.

FIG. 8B depicts the circuit operations when the AC current is in the negative cycle. In the negative cycle, as the lower switch S2 of the inverter 210 is closed and the upper switch S2 is opened, the DC current input to the both ends of the inverter 210 goes to the low level. Current flows from the lower switch S1 to the capacitor Ca in a counterclockwise direction via the coil L2.

The current (the primary current) is induced to the three secondary coils by the transformer 230. In view of the uppermost secondary circuit, the induced secondary current flows from the coil L21 to the lower LED array of the LED array pairs 290 via the diode D4. Thus, the lower LED array radiates in proportion to the applied current.

The current passing through the lower LED array moves to the coil L21 via the diode D1 and the balancing capacitor Cb1. Consequently, the current loop of the coil L21—the diode D4—the lower LED array—the diode D1—the balancing capacitor Cb1—the coil L21 is formed.

When the AC current is in the negative cycle as above, electric charges corresponding to the voltage drop of the lower LED array are accumulated at the capacitor C2. Likewise, the electric charges accumulated at the capacitor C1 during the positive cycle before the negative cycle move to the upper LED array of the LED array pairs 290. Thus, the upper LED array radiates in proportion to the applied current.

In FIGS. 3 and 7, it has been mentioned that the AC current balancing is performed to make the AC currents which are output to the LED array pairs 290 the same through impedance balancing, and that the balanced AC currents are applied to the three rectifiers 270.

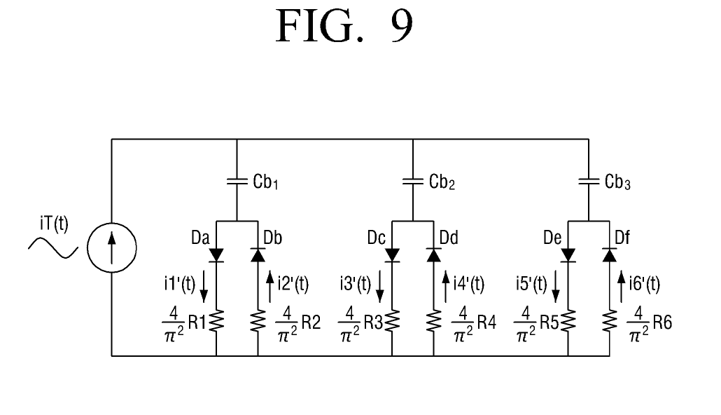

In the following, the identical AC currents applied to the 6 LED arrays according to the three identical AC currents balanced are explained by referring to FIG. 9.

FIG. 9 depicts an equivalent circuit of the secondary circuit of FIG. 3. Current source iT(t) is the current source equivalently representing the current induced to the secondary, Cb1, Cb2, and Cb3 are the balancing capacitors of the balancer 250, and i1′(t), i2′(t), i3′(t), i4′(t), i5′(t) and i6′(t) are the AC equivalent currents viewed from the current source iT(t). Da, Db, Dc, Dd, De and Df are the equivalent diodes for D2+D3, D1+D4, D6+D7, D5+D8, D10+D11 and D9+D12.

Provided that the DC equivalent impedances for the 6 LED arrays are R1, R2, R3, R4, R5 and R6, the AC equivalent impedance for the LED array in consideration of the rectifier effect viewed from the current source can be expressed as the following equation:

$${R}_{AC} = \frac{4}{{π}^{2}} {R}_{DC} \qquad ( 3 )$$

where R_{AC} is the AC equivalent impedance for the LED array in consideration of the rectifier effect viewed from the current source, and R_{DC} is the DC equivalent impedance for the 6 LED array.

Accordingly, the AC equivalent impedances for the 6 LED arrays are 4R1/πi², 4R2/π², 4R3 /π², 4R4/π², 4R5/π² and 4R6/π².

Assuming that the AC current is given by Equation (4), I_{T} and I1˜I6 have the relations expressed by Equation (5):

i_{T}(t)=I_{T} sin(wt)

i_{N}′(t)=I_{N}′sin(wt), (0≦wt<π, N=1,3,5)

i_{N}′(t)=0, (π≦wt<2π, N=1,3,5)

i_{N}′(t)=0(0≦wt<π, N=2,4,6)

i_{N}′(t)=I_{N}′sin(wt), (π≦wt<2π, N=2,4,6) (4)

I₁′=πI₁, I₂′=πI₂, I₃′=πI₃, =I₄′=πI₄, I₅′=πI₅, I₆′=πI₆ I₁′+I₃′+I₅′=I₂′+I₄′+I₆′=I_{T}

As stated earlier, when the impedance of the balancing capacitors Cb1, Cb2 and Cb3 is set to be much higher than R1, R2, R3, R4, R5 and R6, Equation (6) is given. Based on Equation (5) and Equation (6), the DC current balancing is carried out as expressed in Equation

$$\begin{matrix}{I}_{1}^{′} = {I}_{3}^{′} = {I}_{5}^{′} , {I}_{2}^{′} = {I}_{4}^{′} = {I}_{6}^{′} \\ {I}_{1}^{′} = {I}_{3}^{′} = {I}_{5}^{′} = {I}_{2}^{′} = {I}_{4}^{′} = {I}_{6}^{′} = \frac{{I}_{T}}{3} & ( 6 ) \\ {I}_{1} = {I}_{3} = {I}_{5} = {I}_{2} = {I}_{4} = {I}_{6} = \frac{{I}_{T}}{3 π} & ( 7 )\end{matrix}$$

Therefore, as the same DC current is applied to the 6 LED arrays, the current balancing of the 6 LED arrays is accomplished.

The capacitive load is the lossless load. By connecting the balancing capacitors Cb1, Cb2 and Cb3, which are the capacitive loads, to the LED arrays in parallel, the loss for the balancing does not occur. In addition, without a separate LED driving section, only the single SMPS section 150 capable of performing the power supply and the AC current balancing at the same time can contribute to the high efficiency and the thinness of the lighting apparatus.

The lighting apparatus 100 (see FIG. 1) can be used as the backlight of a display device. Now, the LCD display device to which the present invention is applicable is illustrated.

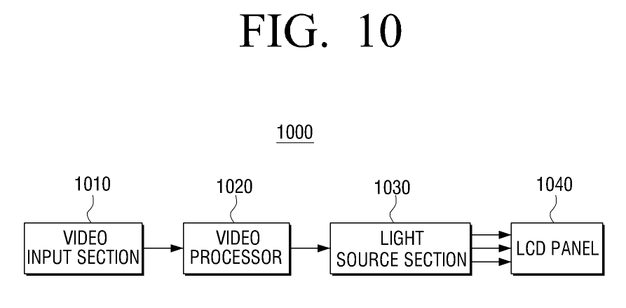

FIG. 10 illustrates an LCD display device 1000 to which the lighting apparatus 100 can be applied according to an exemplary embodiment of the present invention. The LCD display device 1000 of FIG. 10 includes a video input section 1010, a video processor 1020, a light source section 1030, and a panel section 1040.

The video input section 1010 includes an interface for connecting with an external device or an external system. The video input section 1010 receives video from the external device or the external system and forwards the input video to the video processor 1020.

The video processor 1020 generates a video signal by converting the input video into the form suitable for the LCD panel 1040, and generates a radiation signal required by the light source section 1030. The video processor 1020 generates a signal to drive the PFC section 130 and the SMPS section 150 of the lighting apparatus 100 and sends the generated signal to the light source section 1030.

The light source section 1030 includes the PFC section 130, the SMPS section 150, and the LED section 170. The light source section 1030 controls the three LED array pairs, that is, the 6 LED arrays, to radiate by rectifying the input power, correcting the power factor, and performing the current balancing to input the same currents to the LED arrays based on the signal received from the video processor 1020.

The light emitted from the light source section 1030 travels to the LCD panel 1040. The LCD panel 1040 regulates the transmittance of the light produced from the light source section 1030 to display the video signal on the screen. The LCD panel 1040 is fabricated by disposing two substrates including electrodes to face each other and injecting a crystal liquid material in between the two substrates. Herein, when the voltage is applied to the two electrodes, the electric field is generated to move molecules of the crystal liquid material injected between the two substrates, thus regulating the transmittance of the light.

So far, it has been described that the lighting apparatus 100 includes the three LED array pairs, which is only an example to ease the understanding. Note that the embodiments of the present invention are applicable to two or more LED array pairs or four or more LED array pairs and it is not necessary that two LED arrays form the pair. The number of the balancers and the number of the rectifiers can be changed according to the number of the LED arrays within the scope of the present invention.

It should be appreciated that the above-mentioned LED arrays include a green LED array, a blue LED array, and a red LED array.

The technical idea of the present invention is not limited to the LED used as the light source and is applicable to every light source with a DC load. In addition, the present invention can be applied to the light sources with an AC load, for example, but not limited to, Cold Cathode Fluorescence Lamps (CCFL) and Flat Fluorescent Lamps (FFL).

The load mentioned above is not limited to the load of the light source and can employ any load other than the light source or the lighting.

While a detailed circuit configuration has been described, the circuitry is only an example to explain the technical idea of the present invention. Notably, the circuits, the equivalent circuits, the simple circuit modified in the structure, or the circuits with some elements replaced/removed/added are within the spirit and the scope of the invention.

As set forth above, the luminance imbalance caused by dispersion of the light source can be addressed and high efficiency and ultra thin design of the lighting apparatus can be realized.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A current balancing apparatus comprising:
a balancer which balances an input Alternating Current (AC) current by impedance balancing; and
a rectifier which generates a Direct Current (DC) current by rectifying the balanced current.

2. The current balancing apparatus of claim 1, wherein the balancer comprises at least one balancing capacitor, and
the impedance balancing sets at least one of a frequency of the AC current input to the balancing capacitor and a capacitance of the balancing capacitor, to a value lower than a preset value.

3. The current balancing apparatus of claim 2, wherein the preset value is within a range where an impedance value seen by the balancing capacitor looking toward the rectifier is negligible compared to an impedance value of the balancing capacitor.

4. The current balancing apparatus of claim 1, wherein the balancer comprises at least one balancing capacitor, and
the capacitor is connected with the rectifier in series.

5. The current balancing apparatus of claim 1, wherein the rectifier applies the DC current to a plurality of loads, and
the balancer balances the AC current such that the same DC current is input to the plurality of the loads or such that the DC current input to one of the plurality of the loads is equal to a DC current input to another of the plurality of loads connected to another balancer.

6. The current balancing apparatus of claim 1, wherein the rectifier applies the DC current output from a primary end of the rectifier to a first load when the AC current is in a positive cycle, and applies the DC current output from a secondary end of the rectifier to a second load when the AC current is in a negative cycle.

7. The current balancing apparatus of claim 6, wherein the rectifier comprises:
a first capacitor connected to the first load in parallel; and
a second capacitor connected to the second load in parallel, and
the current output from the first capacitor is input to the first load when the AC current is in the negative cycle, and the current output from the second capacitor is input to the second load when the AC current is in the positive cycle.

8. The current balancing apparatus of claim 6, wherein the first load and the second load are a first Light Emitting Diode (LED) array and a second LED array, respectively.

9. A power supply apparatus comprising:
an inverter which converts a DC current to an AC current;
a transformer which converts the AC current which is a primary end current, to a plurality of secondary end currents and transfers the converted currents; and
a plurality of balancers which receive the secondary end currents, balance the secondary end currents by impedance balancing, and generate a plurality of DC currents by rectifying the balanced currents.

10. The power supply apparatus of claim 9, wherein the plurality of balancer transfers the plurality of DC currents to a plurality of load sets, respectively, and
the load sets comprise LED array pairs.

11. The power supply apparatus of claim 9, wherein the plurality of balancers are linked to one secondary coil of the transformer in parallel, or to a plurality of secondary coils of the transformer, respectively.

12. The power supply apparatus of claim 11, wherein, when the plurality of balancers are connected to the one secondary coil of the transformer, each of the plurality of balancers comprises two balancing capacitors, one balancing capacitor of each of the plurality of balancers linked to one end of the secondary coil, and the other balancing capacitor of each of the plurality of balancers linked to the other end of the secondary coil.

13. The power supply apparatus of claim 11, wherein, when the plurality of balancers are connected to the plurality of secondary coils of the transformer, the plurality of the balancers each comprises a balancing capacitor linked to one end of the secondary coil.

14. The power supply apparatus of claim 9, wherein the plurality of DC currents is applied to the plurality of load sets, the currents output from the load sets are combined and input to the inverter, and
the inverter receives the combined current, controls a duty or a frequency of the DC current based on the combined current, chops and converts the DC current to the AC current of a certain level based on the duty control or the frequency control.

15. A lighting apparatus comprising:
a power supply apparatus which balances an AC current by impedance balancing, and generates a plurality of DC currents by rectifying the balanced current; and
a plurality of LED array pairs which receive the plurality of the DC currents generated by the power supply apparatus.

16. A current balancing method comprising:
balancing an input AC current by impedance balancing; and
generating a DC current by rectifying the balanced current.

17. The current balancing method of claim 16, wherein the impedance balancing sets at least one of a frequency of the AC current input to a balancing capacitor and a capacitance of the balancing capacitor, to a value lower than a preset value.

18. The current balancing method of claim 17, wherein the preset value is within a range where an impedance value seen by the balancing capacitor looking toward the rectifier is negligible compared to an impedance value of the balancing capacitor.
